(19) United States
(12) Patent Application Publication
(10) Pub. No.: US 2025/0321570 A1
(43) Pub. Date: Oct. 16, 2025

(54) INTELLIGENT AUTOMATION OF PLANT INFORMATION REAL-TIME DATA TAG CONFIGURATION AND QUALITY ASSURANCE/QUALITY CONTROL

(71) Applicant: Saudi Arabian Oil Company, Dhahran (SA)

(72) Inventors: Abdulmohsen A. Tammar, Udhailiyah (SA); Sarah A. Thawaiqib, Udhailiyah (SA); Mohammed Abdulmohsin Mukhtar, Udhailiyah (SA); Mohammad R. Omran, Udhailiyah (SA)

(21) Appl. No.: 18/635,790

(22) Filed: Apr. 15, 2024

(51) Int. Cl. G05B 19/418

(52) U.S. Cl. CPC G05B 19/41875; G05B 2219/32368; G05B 2219/32404

(57) ABSTRACT

A computer-implemented method for plant information (PI) real-time data tag automatic configuration and quality assurance/quality control (QA/QC), includes detecting installation of a new well or piece of equipment. A plant information (PI) real-time data tag configuration workflow is triggered. A notification of a set of one or more potential PI real-time data tags to configure is received, where the set of one or more potential PI real-time data tags are associated with the new well or piece of equipment. As selected PI real-time data tags, a selection is received from the set of one or more potential PI real-time data tags to configure. The selected PI real-time data tags are automatically configured and the PI real-time data tags are periodically checked against pre-determined standards or logic.

### BACKGROUND

Configuring plant information (PI) real-time data tags is a fundamental aspect of well and equipment installation and maintenance within the oil and gas industry. The PI real-time data tags are indispensable for continuous monitoring and optimization of well and equipment performance, and provide real-time data that informs decision-making and operational adjustments. However, the current process of configuring the PI real-time data tags is predominantly manual, which is not only time-consuming but also susceptible to errors and inconsistencies. The manual nature of the process adversely affects quality and reliability of data and impedes real-time monitoring and maintenance of wells and equipment.

### SUMMARY

The present disclosure describes intelligent automation of plant information (PI) real-time data tag configuration and quality assurance/quality control (QA/QC).

In an implementation, a computer-implemented method for plant information (PI) real-time data tag automatic configuration and quality assurance/quality control (QA/QC), comprises: detecting installation of a new well or piece of equipment; triggering a plant information (PI) real-time data tag configuration workflow; receiving a notification of a set of one or more potential PI real-time data tags to configure, wherein the set of one or more potential PI real-time data tags are associated with the new well or piece of equipment; receiving, as selected PI real-time data tags, a selection from the set of one or more potential PI real-time data tags to configure; automatically configuring the selected PI real-time data tags; and periodically checking the PI real-time data tags against pre-determined standards or logic.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, the described approach for automated configuration of PI real-time data tags and their QA/QC streamlines the configuration of new PI real-time data tags and the QA/QC of existing tags, thereby significantly reducing manual effort, enhancing data quality, accuracy, and consistency, and enabling real-time monitoring and maintenance. Second, the described approach reduces risk of errors and inconsistencies. Third, the automated configuration permits real-time, continuous data transmission. Fourth, the described approach harnesses the power of machine learning (ML) algorithms to recommend PI real-time data tags based on well and equipment information. Fifth, the described approach integrates seamlessly with existing communication channels, permitting periodic checks of existing PI real-time data tags to ensure proper configuration, which will enhance operational performance/efficiency, prompt operational adjustments, and reduce downtime and maintenance costs. This proactive approach to maintenance can lead to substantial time and cost savings. Increases in operational efficiency can lead to increased productivity and better utilization of resources. Periodic checks also further improve data quality and accuracy. Sixth, the described approach can benefit different stakeholders in the oil and gas industry. For example, for operators, the automated process ensures that wells and equipment are online and transmit real-time data, thereby facilitating their job. For engineers, the described approach can save travel time to a plant and allows for focus on PI real-time data tag analysis. For managers, the described approach provides a clear vision of a future path for development opportunities, thereby aiding in decision-making.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a flowchart illustrating a manual process for configuring plant information (PI) real-time data tags and quality assurance/quality control (QA/QC), according to an implementation of the present disclosure.

FIG. 2 is a flowchart illustrating an enhanced process for configuring PI real-time data tags and QA/QC, according to an implementation of the present disclosure.

FIG. 3A is a partial flowchart of a configuration process for a new well, according to an implementation of the present disclosure.

FIG. 3B is a continuation of the partial flowchart from FIG. 3A of a configuration process for a new well, according to an implementation of the present disclosure.

FIG. 4A is a partial flowchart of a configuration process for an existing well, according to an implementation of the present disclosure.

FIG. 4B is a continuation of the partial flowchart from FIG. 4A of a configuration process for an existing well, according to an implementation of the present disclosure.

FIG. 5 is a block diagram illustrating an example of a computer-implemented system used to provide computational functionalities associated with described algorithms, methods, functions, processes, flows, and procedures, according to an implementation of the present disclosure.

FIG. 6 illustrates hydrocarbon production operations that include both one or more field operations and one or more computational operations, which exchange information and control exploration for the production of hydrocarbons, according to an implementation of the present disclosure.

Like reference numbers and designations in the various drawings indicate like elements.

### DETAILED DESCRIPTION

The following detailed description describes intelligent automation of plant information (PI) real-time data tag configuration and quality assurance/quality control (QA/QC) and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

When a new well or piece of equipment is installed, this action necessitates PI real-time data tag configuration, which is a fundamental aspect of well and equipment installation and maintenance within the oil and gas industry. The PI real-time data tags are indispensable for continuous monitoring and optimization of well and equipment operational performance/efficiency, and provide real-time data that informs decision-making and operational adjustments. For example, PI is related to all fields equipped with all assets, especially the real time equipment and is governed and controlled by individuals with specified authority access. The current process of configuring the PI real-time data tags is predominantly manual, which is not only time-consuming but also susceptible to errors and inconsistencies. The manual nature of the process adversely affects quality and reliability of data and impedes real-time monitoring and maintenance of wells and equipment.

Conventionally, a specific entity (e.g., a vendor) shoulders responsibility for identifying a set of PI real-time data tags and associated attributes to be configured. Normally, the PI real-time data tags are configured by the specific entity at a Supervisory Control and Data Acquisition (SCADA) level and subsequently at a PI server level.

When PI real-time data tag identification and configuration process is performed manually, the process is exposed to potential human error. The specific entity (e.g., vendor) must be available during the process to ensure correct format and logic is built on the SCADA. Action(s) associated with the process is subject to a person's knowledgebase and best practices, which can compromise the integrity of the configuration process. An intelligent field (I-field) production engineer then validates the configured PI real-time data tags in a PI server and ensures all required PI real-time data tags for monitoring and analysis are completed. Regular QA/QC is performed by the I-field production engineer on each PI real-time data tag to ensure reliability and availability are maintained.

The manual configuration and QA/QC processes are also subject to risk of error and inconsistencies, and sometimes the lack of real-time, continuous data transmission. The maintenance of SCADA is a key factor that plays an important role in sustainability of real-time data. The challenges and limitations of the current process, such as a need for manual configuration, a risk of errors and inconsistencies, and a lack of real-time monitoring and maintenance, necessitate an improvement to PI real-time data tag configuration and QA/QC.

Described is an approach to automate configuration of PI real-time data tags and their QA/QC, which streamlines the configuration of new PI real-time data tags and the QA/QC of existing tags, thereby significantly reducing manual effort, enhancing accuracy and consistency, and enabling real-time monitoring and maintenance. The approach also harnesses the power of machine learning (ML) algorithms to recommend PI tags based on well & equipment information, integrates seamlessly with existing communication channels, and periodically checks existing PI tags to ensure proper configuration, which will enhance operational performance/efficiency, reduce downtime and maintenance costs, and improve data quality and accuracy.

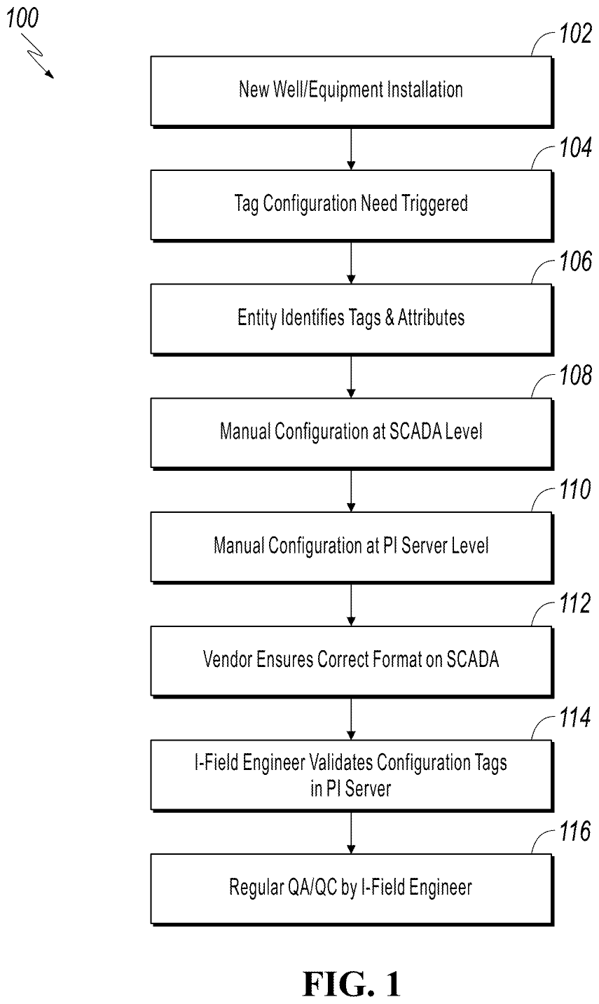

FIG. 1 is a flowchart illustrating a manual process 100 for configuring PI real-time data tags and QA/QC, according to an implementation of the present disclosure.

At 102, installation of a new well or piece of equipment occurs. From 102, process 100 proceeds to 104.

At 104, a need for a PI real-time data tag(s) configuration is triggered. From 104, process 100 proceeds to 106.

At 106, a specific entity (e.g., a vendor) identifies a set of PI real-time data tags and their attributes to be configured. From 106, process 100 proceeds to 108.

At 108, a manual configuration of the PI real-time data tags is performed at the SCADA level. From 108, process 100 proceeds to 110.

At 110, a manual configuration of the PI real-time data tags is performed at the PI server level. From 110, process 100 proceeds to 112.

At 112, the specific entity ensures correct format and logic is built on the SCADA the during configuration of the set of PI real-time data tags. From 112, process 100 proceeds to 114.

At 114, an I-field production engineer validates the configured PI real-time data tags in the PI server. From 114, process 100 proceeds to 116.

At 116, regular QA/QC is performed by the I-field production engineer for each PI real-time data tag. After 116, process 100 can stop.

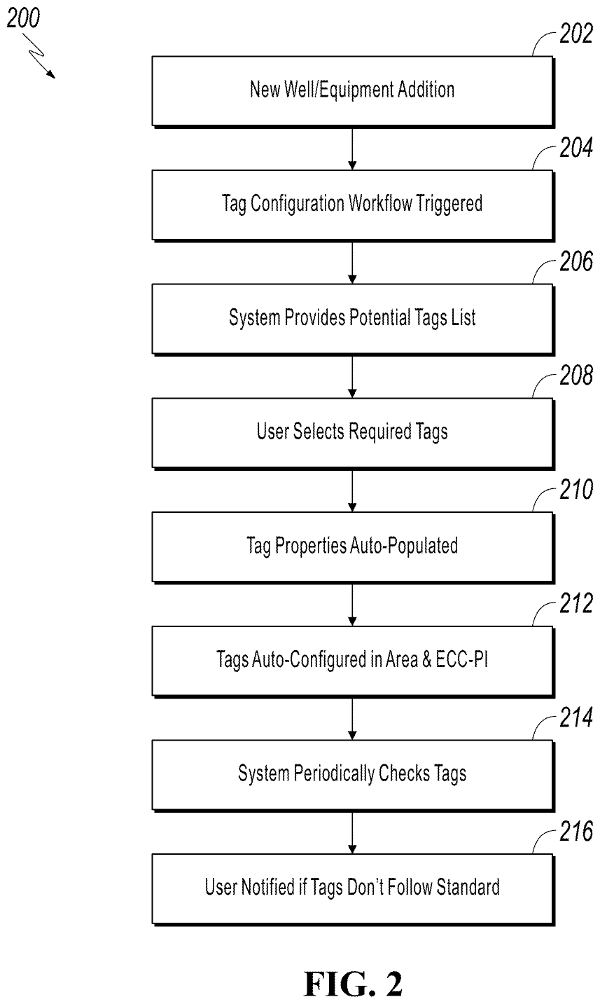

FIG. 2 is a flowchart illustrating an enhanced process 200 for configuring PI real-time data tags and QA/QC, according to an implementation of the present disclosure.

The described enhanced process 200 addresses the previously identified challenges and limitations of a manual process. Enhanced process 200 permits automated PI real-time data tag configuration and QA/QC, streamlining configuration of new PI real-time data tags and QA/QC of existing PI real-time data tags. By automating PI real-time data tag configuration and QA/QC processes, enhanced process 200 reduces manual effort, improves accuracy and consistency, and enables real-time monitoring and maintenance.

In some implementations, key features of the enhanced process 200 can include:

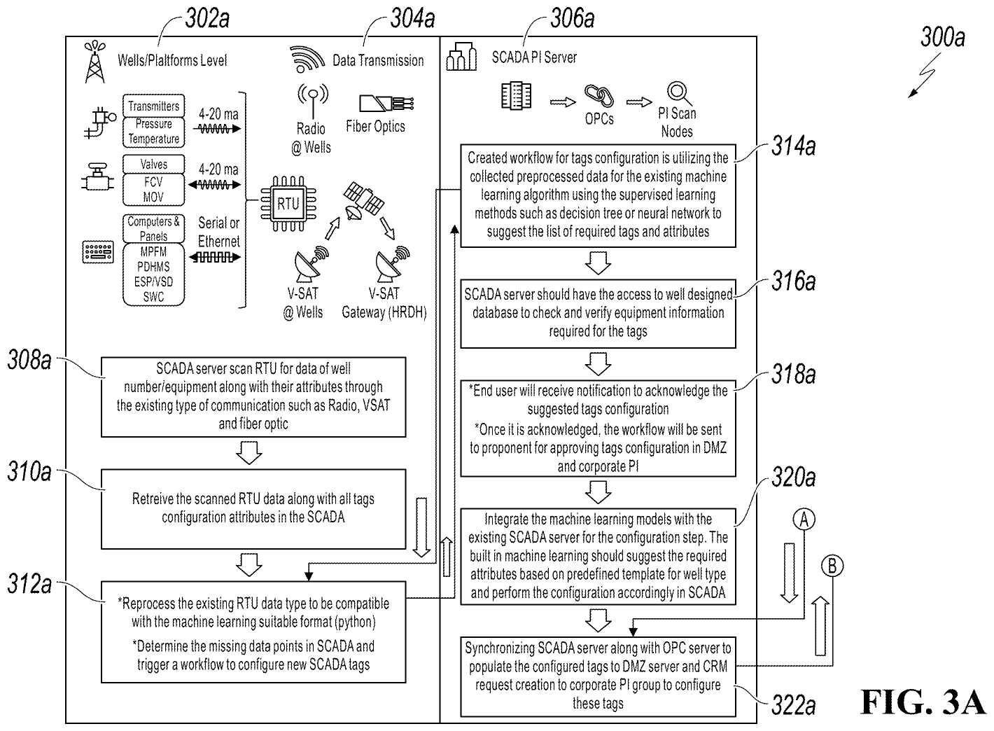

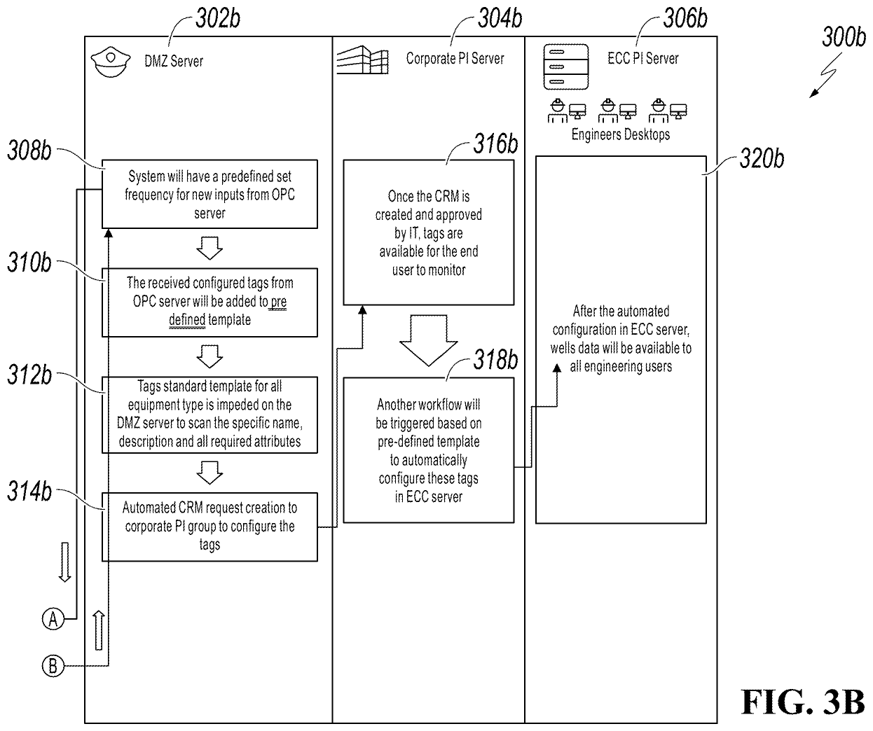

(1) New PI real-time data tag generation: Whenever a new well or piece of equipment is added to a database (e.g., a database for wells and equipment associated with a specific I-field), a PI real-time data tag configuration workflow is triggered. A user of a computing system can be provided with a list of potential PI real-time data tags based on, for example, a well type, field, equipment type, and vendor. The user can then select required PI real-time data tags. PI real-time data tag properties (e.g., zero, span, and compression) associated with PI real-time data tags are automatically populated according to a pre-determined standards or logic. The PI real-time data tags are then automatically configured in the area (or corporate PI server-such as, 304b in FIG. 3B) and enterprise resource planning/PI computing systems.

(2) PI real-time data tag configuration and QA/QC: PI real-time data tag configuration against standards or logic is periodically checked. If, for example, any of the PI real-time data tag properties, description, or tag mask is not following the standards, the user is notified of the case and can recommend a correction. In some implementations, notifications are automatically generated and can include emails linked with a specific role and application dashboard notification pop-up window once the application dashboard is accessed.

Enhanced process 200 leverages ML algorithms to recommend PI real-time data tags based on well/equipment information. In some implementations, the algorithms are trained/built based on historical data for all types of wells. The enhanced process 200 also integrates with existing PI real-time data tag communication channels, which permits the described periodic checks of existing PI real-time data tags to ensure proper configuration.

Turning now to FIG. 2, enhanced process 200:

At 202, installation of a new well or piece of equipment occurs. From 202, enhanced process 200 proceeds to 204.

At 204, a PI real-time data tag(s) configuration workflow is triggered. From 204, enhanced process 200 proceeds to 206.

At 206, a computing system provides a set of potential PI real-time data tags and their attributes to be configured. From 206, enhanced process 200 proceeds to 208.

At 208, a user selects required PI real-time data tags from the provided set of potential PI real-time data tags. In some implementations, a computer system can perform automated selection of PI real-time data tags. From 208, enhanced process 200 proceeds to 210.

At 210, properties of the PI real-time data tags are automatically populated based on pre-determined standards or logic. From 210, enhanced process 200 proceeds to 212.

At 212, the selected PI real-time data tags are automatically configured in the area and enterprise resource planning/PI computing systems. From 212, enhanced process 200 proceeds to 214.

At 214, PI real-time data tag configuration against standards or logic is periodically checked. From 214, enhanced process 200 proceeds to 216.

At 216, if it is determined that any of the PI real-time data tag properties, description, or tag mask is not following the standards, the user is notified of the case and a correction can be recommended. After 216, enhanced process 200 can stop.

FIG. 3A is a partial flowchart of a configuration process 300a for a new well, according to an implementation of the present disclosure.

In some implementations, the computer-implemented system associated with FIG. 3A includes wells/platform level 302a, data transmission 304a, and SCADA PI server 306a. The wells/platform level 302a can includes, for example, transmitters, valves, and computers and panels. The data transmission 304a can includes radio at wells, fiber optics, remote terminal units (RTUs), and satellite technology (e.g., very small aperture terminal (VSAT)). The SCADA PI Server 306a can include computer servers, open platform communications (OPCs), and PI scan nodes.

At 308a, a SCADA server scans an RTU for data of well number/equipment along with associated attributes through an existing communication method (e.g., radio, VSAT, and fiber optic). From 308a, configuration process 300a proceeds to 310a.

At 310a, the scanned RTU data along with all PI real-time data tag configuration attributes is retrieved in the SCADA PI server 306a. From 310a, configuration process 300a proceeds to 312a.

At 312a, the RTU data type is reprocessed to be compatible with the ML algorithms (i.e., data format required by the ML algorithms—e.g., PYTHON). Also, any missing data points in the SCADA PI server 306a are identified and a workflow triggered to configure new SCADA PI server 306 tags. From 312a, configuration process 300a proceeds to 314a.

At 314a, the triggered workflow for PI real-time data tag configuration utilizes the collected preprocessed data from the existing ML algorithm by using the supervised learning methods, such as decision trees or neural networks to suggest a list of required PI real-time data tags and attributes. From 314a, configuration process 300a proceeds to 316a.

At 316a, the SCADA PI server 306a accesses a database to check and verify equipment information required for the PI real-time data tags. From 316a, configuration process 300a proceeds to 318a.

At 318a, an end user receives notification to acknowledge a suggested PI real-time data tag configuration. Once acknowledged, the workflow is sent to a proponent to approve PI real-time tag configuration in the DMZ server and corporate PI (302b and 304b, respectively in FIG. 3B). From 318a, configuration process 300a proceeds to 320a.

At 320a, ML models are integrated with existing SCADA PI server 306a for configuration. The built-in ML algorithm suggests required attributes based on predefined templates for well type and performs configuration accordingly in the SCADA PI 306a. From 320a, configuration process 300a proceeds to 322a.

At 322a, the SCADA PI server 306a is synchronized with an associated OPC server to populate the configured PI real-time data tags to the DMZ server 302b and generate a customer relationship management (CRM) request to a corporate PI server 304b to configure the PI real-time data tags. From 322a, configuration process 300a proceeds to FIG. 3B and configuration process 300b.

FIG. 3B is a continuation of the partial flowchart from FIG. 3A of a configuration process 300b for a new well, according to an implementation of the present disclosure.

Continuing the computer-implemented system of FIG. 3A, FIG. 3B includes a DMZ server 302b, corporate 304b, and ERP central server 306b.

At 308b, the computer-implemented system has a predefined set frequency for new input from an OPC server. From 308b, configuration process 300b proceeds to 310b.

At 310b, the received configured PI real-time data tags from the OPC server are added to a pre-defined template. From 310b, configuration process 300b proceeds to 312b.

At 312b, PI real-time data tags standard template for all equipment types are impeded on the DMZ server 302b to permit scanning a specific name, description, and all required attributes. From 312b, configuration process 300b proceeds to 314b.

At 314b, an automated CRM request is created to corporate PI server 304b to configuration the PI real-time data tags. From 314b, configuration process 300b proceeds to 316b.

At 316b, once the CRM request is created and approved by an information technology (IT) group, PI real-time data tags are available for the end user to monitor. From 316b, configuration process 300b proceeds to 318b.

At 318b, another workflow is triggered based on a pre-defined template to automatically configure the PI real-time data tags in the ERP central server 306b. From 318b, configuration process 300b proceeds to 320b.

At 320b, after the automated configuration in the ERP central server 306b, well data will be available to all engineering users. After 320b, configuration process 300b can stop.

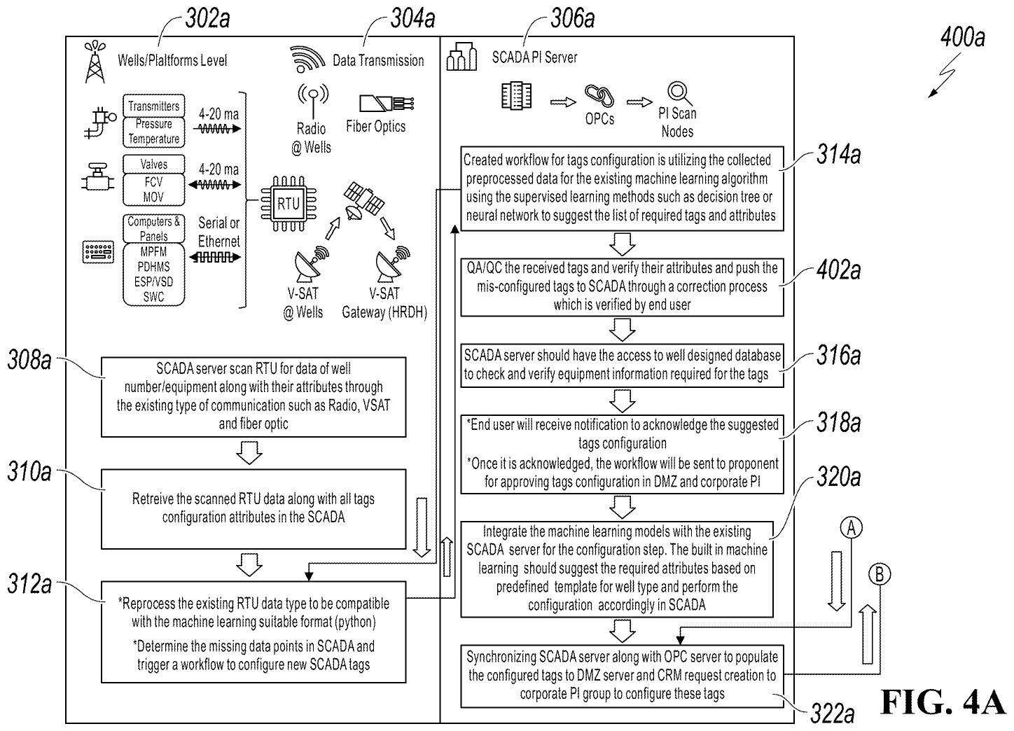

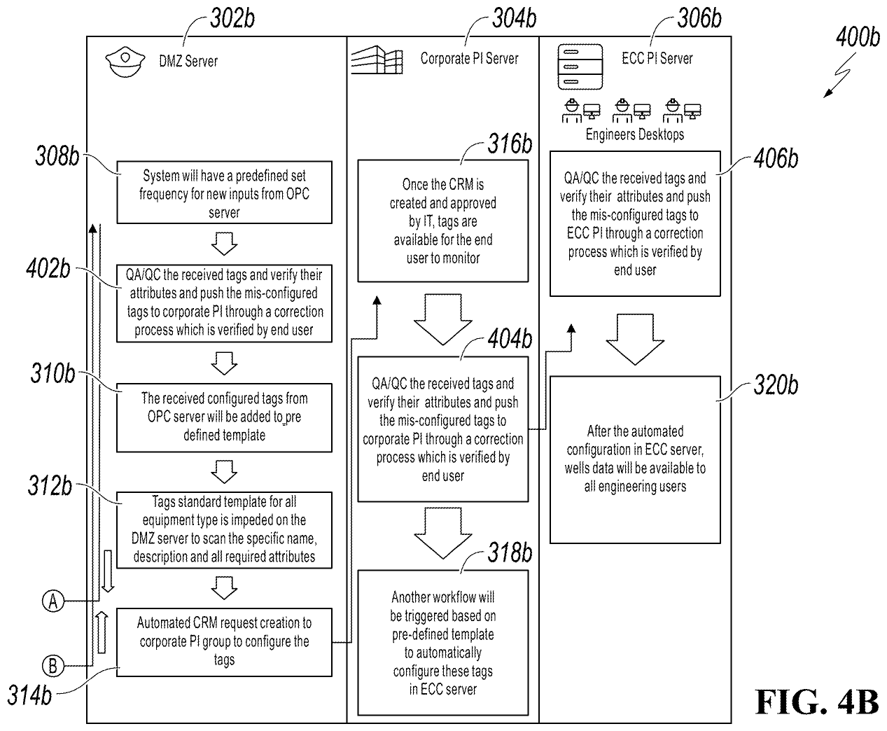

FIG. 4A is a partial flowchart of a configuration process 400a for an existing well, according to an implementation of the present disclosure.

As described in FIG. 3A, the computer-implemented system associated with FIG. 4A includes wells/platform level 302a, data transmission 304a, and SCADA PI server 306a. The configuration process 400a in FIG. 4A is identical to that as described with respect to FIG. 3A, except for a step 402a inserted between 314a and 316a.

At 402a, the received PI real-time data tags are QA/QC and their attributes are verified. Any mis-configured PI real-time data tags are pushed to the SCADA PI server 306a through a correction process which is verified by an end user. For example, the correction process can correct a data tag name, description, and all required attributes per imbedded logic, and an email notification can be sent to a designated individual to verify the correction/correction purpose and supply an acknowledgement. From 402a, configuration process 400a proceeds to 316.

FIG. 4B is a continuation of the partial flowchart from FIG. 4A of a configuration process 300b for an existing well, according to an implementation of the present disclosure.

As described in FIG. 3B, the computer-implemented system associated with FIG. 4B includes a DMZ server 302b, corporate 304b, and ERP central server 306b.

The configuration process 400b in FIG. 4B is identical to that as described with respect to FIG. 3B, except for a step 402b inserted between 308b and 310b, step 404b inserted between 316b and 318b, and 406b inserted between 318b and 320b.

At 402b, the received PI real-time data tags are QA/QC and their attributes are verified. Any mis-configured PI real-time data tags are pushed to the corporate PI server 304b through a correction process (e.g., as previously described in 402a), which is verified by an end user. From 402b, configuration process 400b proceeds to 310b.

At 404b, the received PI real-time data tags are QA/QC and their attributes are verified. Any mis-configured PI real-time data tags are pushed to the ERP central server 306b through a correction process (e.g., as previously described), which is verified by an end user. From 404b, configuration process 400b proceeds to 318b.

At 406b, the received PI real-time data tags are QA/QC and their attributes are verified. Any mis-configured PI real-time data tags are pushed to the ERP central server 306b through a correction process (e.g., as previously described), which is verified by an end user. From 406b, configuration process 400b proceeds to 320b. After 320b, configuration process 400b can stop.

In some implementations, an advantage of the described approach is to quantify carbon emissions to permit planning and reduction of carbon emissions. For example, to determine carbon emissions, a current PI real-time data tag configuration process per well can be associated with a presence of two (2) individuals travelling 500 km to a designated SCADA server location and back to their offices. The following is detail of an example calculation of carbon emissions:

$$Number of Attendances per well and trip distance = ( 2 individuals ) , ( 2 * 500 = 1 , 000 km ) \\ Amount of fuel ( gallon ) = \frac{1 , 000 * 0.1667}{3.785} = 44.03 gallons$$

$$Value added from fuel ( \$ ) per well = 44.03 * 0.1667 * 2.18 = \$16 \\ Carbon Emissions ( metric tons ) = 44.03 * 0.0087 = 0.39 metric tons .$$

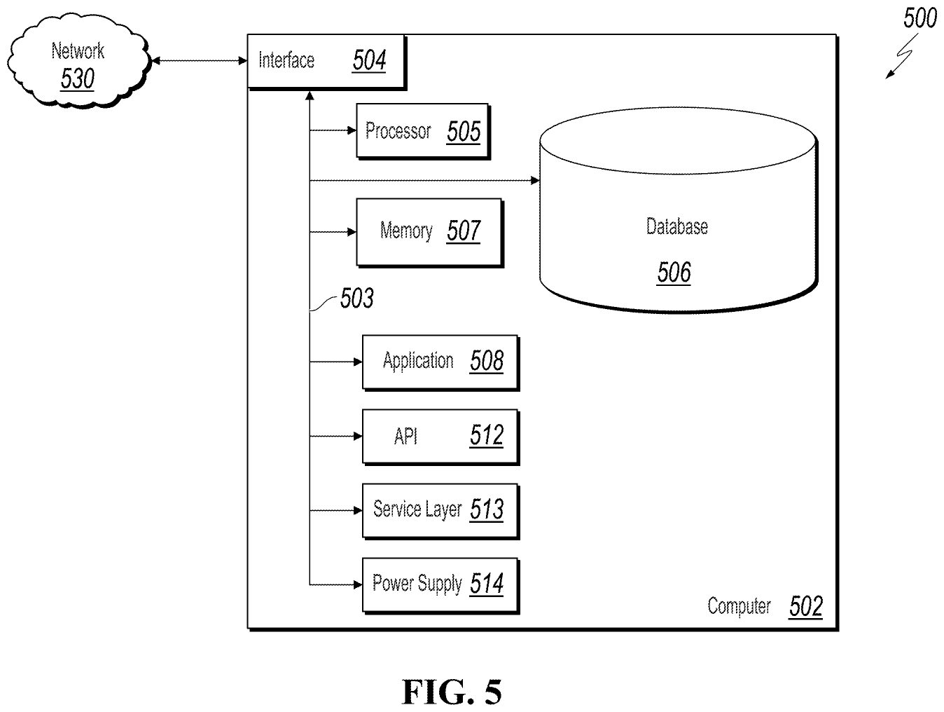

FIG. 5 is a block diagram illustrating an example of a computer-implemented System 500 used to provide computational functionalities associated with described algorithms, methods, functions, processes, flows, and procedures, according to an implementation of the present disclosure. In the illustrated implementation, computer-implemented system 500 includes a Computer 502 and a Network 530.

The illustrated Computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 502 can include an input device, such as a keypad, keyboard, or touch screen, or a combination of input devices that can accept user information, and an output device that conveys information associated with the operation of the Computer 502, including digital data, visual, audio, another type of information, or a combination of types of information, on a graphical-type user interface (UI) (or GUI) or other UI.

The Computer 502 can serve in a role in a distributed computing system as, for example, a client, network component, a server, or a database or another persistency, or a combination of roles for performing the subject matter described in the present disclosure. The illustrated Computer 502 is communicably coupled with a Network 530. In some implementations, one or more components of the Computer 502 can be configured to operate within an environment, or a combination of environments, including cloud-computing, local, or global.

At a high level, the Computer 502 is an electronic computing device operable to receive, transmit, process, store, or manage data and information associated with the described subject matter. According to some implementations, the Computer 502 can also include or be communicably coupled with a server, such as an application server, e-mail server, web server, caching server, or streaming data server, or a combination of servers.

The Computer 502 can receive requests over Network 530 (for example, from a client software application executing on another Computer 502) and respond to the received requests by processing the received requests using a software application or a combination of software applications. In addition, requests can also be sent to the Computer 502 from internal users (for example, from a command console or by another internal access method), external or third-parties, or other entities, individuals, systems, or computers.

Each of the components of the Computer 502 can communicate using a System Bus 503. In some implementations, any or all of the components of the Computer 502, including hardware, software, or a combination of hardware and software, can interface over the System Bus 503 using an application programming interface (API) 512, a Service Layer 513, or a combination of the API 512 and Service Layer 513. The API 512 can include specifications for routines, data structures, and object classes. The API 512 can be either computer-language independent or dependent and refer to a complete interface, a single function, or even a set of APIs. The Service Layer 513 provides software services to the Computer 502 or other components (whether illustrated or not) that are communicably coupled to the Computer 502. The functionality of the Computer 502 can be accessible for all service consumers using the Service Layer 513. Software services, such as those provided by the Service Layer 513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 502, alternative implementations can illustrate the API 512 or the Service Layer 513 as stand-alone components in relation to other components of the Computer 502 or other components (whether illustrated or not) that are communicably coupled to the Computer 502. Moreover, any or all parts of the API 512 or the Service Layer 513 can be implemented as a child or a sub-module of another software module, enterprise application, or hardware module without departing from the scope of the present disclosure.

The Computer 502 includes an Interface 504. Although illustrated as a single Interface 504, two or more Interfaces 504 can be used according to particular needs, desires, or particular implementations of the Computer 502. The Interface 504 is used by the Computer 502 for communicating with another computing system (whether illustrated or not) that is communicatively linked to the Network 530 in a distributed environment. Generally, the Interface 504 is operable to communicate with the Network 530 and includes logic encoded in software, hardware, or a combination of software and hardware. More specifically, the Interface 504 can include software supporting one or more communication protocols associated with communications such that the Network 530 or hardware of Interface 504 is operable to communicate physical signals within and outside of the illustrated Computer 502.

The Computer 502 includes a Processor 505. Although illustrated as a single Processor 505, two or more Processors 505 can be used according to particular needs, desires, or particular implementations of the Computer 502. Generally, the Processor 505 executes instructions and manipulates data to perform the operations of the Computer 502 and any algorithms, methods, functions, processes, flows, and procedures as described in the present disclosure.

The Computer 502 also includes a Database 506 that can hold data for the Computer 502, another component communicatively linked to the Network 530 (whether illustrated or not), or a combination of the Computer 502 and another component. For example, Database 506 can be an in-memory or conventional database storing data consistent with the present disclosure. In some implementations, Database 506 can be a combination of two or more different database types (for example, a hybrid in-memory and conventional database) according to particular needs, desires, or particular implementations of the Computer 502 and the described functionality. Although illustrated as a single Database 506, two or more databases of similar or differing types can be used according to particular needs, desires, or particular implementations of the Computer 502 and the described functionality. While Database 506 is illustrated as an integral component of the Computer 502, in alternative implementations, Database 506 can be external to the Computer 502. The Database 506 can hold and operate on at least any data type mentioned or any data type consistent with this disclosure.

The Computer 502 also includes a Memory 507 that can hold data for the Computer 502, another component or components communicatively linked to the Network 530 (whether illustrated or not), or a combination of the Computer 502 and another component. Memory 507 can store any data consistent with the present disclosure. In some implementations, Memory 507 can be a combination of two or more different types of memory (for example, a combination of semiconductor and magnetic storage) according to particular needs, desires, or particular implementations of the Computer 502 and the described functionality. Although illustrated as a single Memory 507, two or more Memories 507 or similar or differing types can be used according to particular needs, desires, or particular implementations of the Computer 502 and the described functionality. While Memory 507 is illustrated as an integral component of the Computer 502, in alternative implementations, Memory 507 can be external to the Computer 502.

The Application 508 is an algorithmic software engine providing functionality according to particular needs, desires, or particular implementations of the Computer 502, particularly with respect to functionality described in the present disclosure. For example, Application 508 can serve as one or more components, modules, or applications. Further, although illustrated as a single Application 508, the Application 508 can be implemented as multiple Applications 508 on the Computer 502. In addition, although illustrated as integral to the Computer 502, in alternative implementations, the Application 508 can be external to the Computer 502.

The Computer 502 can also include a Power Supply 514. The Power Supply 514 can include a rechargeable or non-rechargeable battery that can be configured to be either user- or non-user-replaceable. In some implementations, the Power Supply 514 can include power-conversion or management circuits (including recharging, standby, or another power management functionality). In some implementations, the Power Supply 514 can include a power plug to allow the Computer 502 to be plugged into a wall socket or another power source to, for example, power the Computer 502 or recharge a rechargeable battery.

There can be any number of Computers 502 associated with, or external to, a computer system containing Computer 502, each Computer 502 communicating over Network 530. Further, the term “client,” “user,” or other appropriate terminology can be used interchangeably, as appropriate, without departing from the scope of the present disclosure. Moreover, the present disclosure contemplates that many users can use one Computer 502, or that one user can use multiple computers 502.

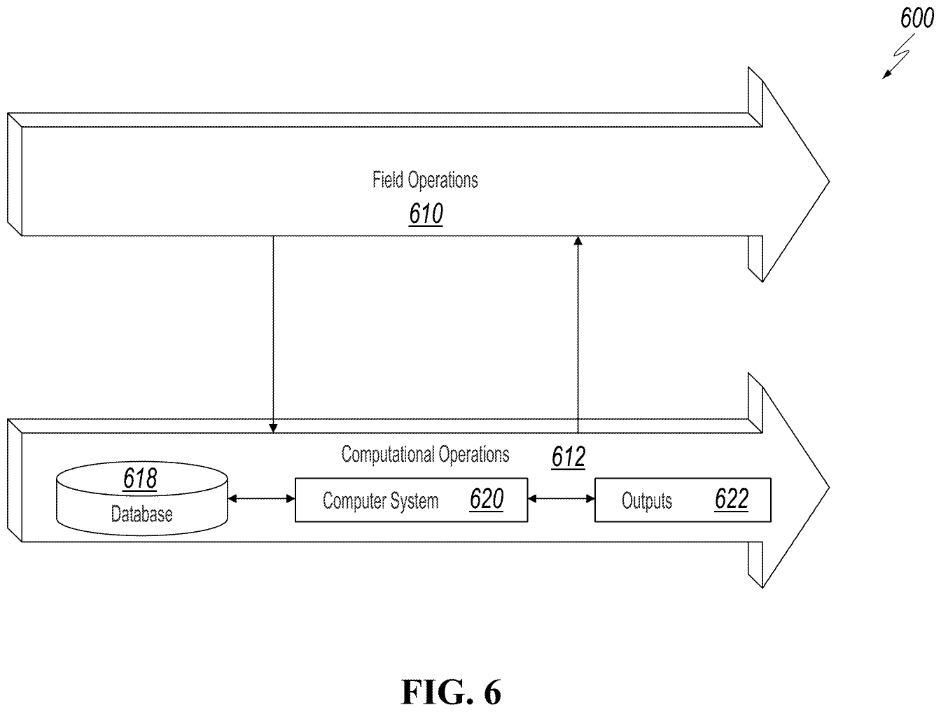

FIG. 6 illustrates hydrocarbon production operations 600 that include both one or more field operations 610 and one or more computational operations 612, which exchange information and control exploration for the production of hydrocarbons. In some implementations, outputs of techniques of the present disclosure can be performed before, during, or in combination with the hydrocarbon production operations 600, specifically, for example, either as field operations 610 or computational operations 612, or both.

Examples of field operations 610 include forming/drilling a wellbore, hydraulic fracturing, producing through the wellbore, injecting fluids (such as water) through the wellbore, to name a few. In some implementations, methods of the present disclosure can trigger or control the field operations 610. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 610 and responsively triggering the field operations 610 including, for example, generating plans and signals that provide feedback to and control physical components of the field operations 610. Alternatively or in addition, the field operations 610 can trigger the methods of the present disclosure. For example, implementing physical components (including, for example, hardware, such as sensors) deployed in the field operations 610 can generate plans and signals that can be provided as input or feedback (or both) to the methods of the present disclosure.

Examples of computational operations 612 include one or more computer systems 620 that include one or more processors and computer-readable media (e.g., non-transitory computer-readable media) operatively coupled to the one or more processors to execute computer operations to perform the methods of the present disclosure. The computational operations 612 can be implemented using one or more databases 618, which store data received from the field operations 610 and/or generated internally within the computational operations 612 (e.g., by implementing the methods of the present disclosure) or both. For example, the one or more computer systems 620 process inputs from the field operations 610 to assess conditions in the physical world, the outputs of which are stored in the databases 618. For example, seismic sensors of the field operations 610 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 612 where they are stored in the databases 618 and analyzed by the one or more computer systems 620.

In some implementations, one or more outputs 622 generated by the one or more computer systems 620 can be provided as feedback/input to the field operations 610 (either as direct input or stored in the databases 618). The field operations 610 can use the feedback/input to control physical components used to perform the field operations 610 in the real world.

For example, the computational operations 612 can process the seismic data to generate three-dimensional (3D) maps of the subsurface formation. The computational operations 612 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 612 to process new information about the formation and control the drilling to adjust to the observed conditions in real-time.

The one or more computer systems 620 can update the 3D maps of the subsurface formation as information from one exploration well is received and the computational operations 612 can adjust the location of the next exploration well based on the updated 3D maps. Similarly, the data received from production operations can be used by the computational operations 612 to control components of the production operations. For example, production well and pipeline data can be analyzed to predict slugging in pipelines leading to a refinery and the computational operations 612 can control machine operated valves upstream of the refinery to reduce the likelihood of plant disruptions that run the risk of taking the plant offline.

In some implementations of the computational operations 612, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Described implementations of the subject matter can include one or more features, alone or in combination.

For example, in a first implementation, a computer-implemented method for plant information (PI) real-time data tag automatic configuration and quality assurance/quality control (QA/QC), comprising: detecting installation of a new well or piece of equipment; triggering a plant information (PI) real-time data tag configuration workflow; receiving a notification of a set of one or more potential PI real-time data tags to configure, wherein the set of one or more potential PI real-time data tags are associated with the new well or piece of equipment; receiving, as selected PI real-time data tags, a selection from the set of one or more potential PI real-time data tags to configure; automatically configuring the selected PI real-time data tags; and periodically checking the PI real-time data tags against pre-determined standards or logic.

The foregoing and other described implementations can each, optionally, include one or more of the following features:

A first feature, combinable with any of the following features, wherein detecting installation of a new well or piece of equipment is performed by a supervisory control and data acquisition (SCADA) PI server, which scans remote terminal unit (RTU) data through one or more existing communication channels.

A second feature, combinable with any of the previous or following features, comprising: retrieving scanned RTU data along with a PI real-time tag and associated configuration attributes.

A third feature, combinable with any of the previous or following features, comprising: automatically populating properties of the selected PI real-time data tags based on the pre-determined standards or logic.

A fourth feature, combinable with any of the previous or following features, wherein automatically populating properties of the selected PI real-time data tags is performed by machine learning (ML) algorithms.

A fifth feature, combinable with any of the previous or following features, wherein the selected PI real-time data tags are automatically configured in a demilitarized zone (DMZ) server and corporate PI server.

A sixth feature, combinable with any of the previous or following features, comprising: determining that any of properties, description, or tag mask of the PI real-time data tags fails to follow the pre-determined standards or logic.

A seventh feature, combinable with any of the previous or following features, comprising: receiving a notification that a property, description, or tag mask of the PI real-time data tags fails to follow the pre-determined standards or logic.

An eighth feature, combinable with any of the previous or following features, comprising: receiving a recommended correction associated with the notification.

A ninth feature, combinable with any of the previous or following features, comprising: performing quality assurance/quality control on the set of one or more potential PI real-time data tags to configure.

In a second implementation, a non-transitory, computer-readable medium storing one or more instructions executable by a computer system to perform one or more operations for plant information (PI) real-time data tag automatic configuration and quality assurance/quality control (QA/QC), comprising: detecting installation of a new well or piece of equipment; triggering a plant information (PI) real-time data tag configuration workflow; receiving a notification of a set of one or more potential PI real-time data tags to configure, wherein the set of one or more potential PI real-time data tags are associated with the new well or piece of equipment; receiving, as selected PI real-time data tags, a selection from the set of one or more potential PI real-time data tags to configure; automatically configuring the selected PI real-time data tags; and periodically checking the PI real-time data tags against pre-determined standards or logic.

The foregoing and other described implementations can each, optionally, include one or more of the following features:

A first feature, combinable with any of the following features, wherein detecting installation of a new well or piece of equipment is performed by a supervisory control and data acquisition (SCADA) PI server, which scans remote terminal unit (RTU) data through one or more existing communication channels.

A second feature, combinable with any of the previous or following features, comprising: retrieving scanned RTU data along with a PI real-time tag and associated configuration attributes.

A third feature, combinable with any of the previous or following features, comprising: automatically populating properties of the selected PI real-time data tags based on the pre-determined standards or logic.

A fourth feature, combinable with any of the previous or following features, wherein automatically populating properties of the selected PI real-time data tags is performed by machine learning (ML) algorithms.

A fifth feature, combinable with any of the previous or following features, wherein the selected PI real-time data tags are automatically configured in a demilitarized zone (DMZ) server and corporate PI server.

A sixth feature, combinable with any of the previous or following features, comprising: determining that any of properties, description, or tag mask of the PI real-time data tags fails to follow the pre-determined standards or logic.

A seventh feature, combinable with any of the previous or following features, comprising: receiving a notification that a property, description, or tag mask of the PI real-time data tags fails to follow the pre-determined standards or logic.

An eighth feature, combinable with any of the previous or following features, comprising: receiving a recommended correction associated with the notification.

A ninth feature, combinable with any of the previous or following features, comprising: performing quality assurance/quality control on the set of one or more potential PI real-time data tags to configure.

In a third implementation, a computer-implemented system for plant information (PI) real-time data tag automatic configuration and quality assurance/quality control (QA/QC), comprising: one or more computers; and one or more computer memory devices interoperably coupled with the one or more computers and having tangible, non-transitory, machine-readable media storing one or more instructions that, when executed by the one or more computers, perform one or more operations, comprising: detecting installation of a new well or piece of equipment; triggering a plant information (PI) real-time data tag configuration workflow; receiving a notification of a set of one or more potential PI real-time data tags to configure, wherein the set of one or more potential PI real-time data tags are associated with the new well or piece of equipment; receiving, as selected PI real-time data tags, a selection from the set of one or more potential PI real-time data tags to configure; automatically configuring the selected PI real-time data tags; and periodically checking the PI real-time data tags against pre-determined standards or logic.

The foregoing and other described implementations can each, optionally, include one or more of the following features:

A first feature, combinable with any of the following features, wherein detecting installation of a new well or piece of equipment is performed by a supervisory control and data acquisition (SCADA) PI server, which scans remote terminal unit (RTU) data through one or more existing communication channels.

A second feature, combinable with any of the previous or following features, comprising: retrieving scanned RTU data along with a PI real-time tag and associated configuration attributes.

A third feature, combinable with any of the previous or following features, comprising: automatically populating properties of the selected PI real-time data tags based on the pre-determined standards or logic.

A fourth feature, combinable with any of the previous or following features, wherein automatically populating properties of the selected PI real-time data tags is performed by machine learning (ML) algorithms.

A fifth feature, combinable with any of the previous or following features, wherein the selected PI real-time data tags are automatically configured in a demilitarized zone (DMZ) server and corporate PI server.

A sixth feature, combinable with any of the previous or following features, comprising: determining that any of properties, description, or tag mask of the PI real-time data tags fails to follow the pre-determined standards or logic.

A seventh feature, combinable with any of the previous or following features, comprising: receiving a notification that a property, description, or tag mask of the PI real-time data tags fails to follow the pre-determined standards or logic.

An eighth feature, combinable with any of the previous or following features, comprising: receiving a recommended correction associated with the notification.

A ninth feature, combinable with any of the previous or following features, comprising: performing quality assurance/quality control on the set of one or more potential PI real-time data tags to configure.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for plant information (PI) real-time data tag automatic configuration and quality assurance/quality control (QA/QC), comprising:
detecting installation of a new well or piece of equipment;
triggering a plant information (PI) real-time data tag configuration workflow;
receiving a notification of a set of one or more potential PI real-time data tags to configure, wherein the set of one or more potential PI real-time data tags are associated with the new well or piece of equipment;
receiving, as selected PI real-time data tags, a selection from the set of one or more potential PI real-time data tags to configure;
automatically configuring the selected PI real-time data tags; and
periodically checking the PI real-time data tags against pre-determined standards or logic.

2. The computer-implemented method of claim 1, wherein detecting installation of a new well or piece of equipment is performed by a supervisory control and data acquisition (SCADA) PI server, which scans remote terminal unit (RTU) data through one or more existing communication channels.

3. The computer-implemented method of claim 2, comprising:
retrieving scanned RTU data along with a PI real-time tag and associated configuration attributes.

4. The computer-implemented method of claim 1, comprising:
automatically populating properties of the selected PI real-time data tags based on the pre-determined standards or logic.

5. The computer-implemented method of claim 4, wherein automatically populating properties of the selected PI real-time data tags is performed by machine learning (ML) algorithms.

6. The computer-implemented method of claim 1, wherein the selected PI real-time data tags are automatically configured in a demilitarized zone (DMZ) server and corporate PI server.

7. The computer-implemented method of claim 1, comprising:
determining that any of properties, description, or tag mask of the PI real-time data tags fails to follow the pre-determined standards or logic.

8. The computer-implemented method of claim 7, comprising:
receiving a notification that a property, description, or tag mask of the PI real-time data tags fails to follow the pre-determined standards or logic.

9. The computer-implemented method of claim 8, comprising:
receiving a recommended correction associated with the notification.

10. The computer-implemented method of claim 1, comprising:
performing quality assurance/quality control on the set of one or more potential PI real-time data tags to configure.

11. A non-transitory, computer-readable medium storing one or more instructions executable by a computer system to perform one or more operations for plant information (PI) real-time data tag automatic configuration and quality assurance/quality control (QA/QC), comprising:
detecting installation of a new well or piece of equipment;
triggering a plant information (PI) real-time data tag configuration workflow;
receiving a notification of a set of one or more potential PI real-time data tags to configure, wherein the set of one or more potential PI real-time data tags are associated with the new well or piece of equipment;
receiving, as selected PI real-time data tags, a selection from the set of one or more potential PI real-time data tags to configure;
automatically configuring the selected PI real-time data tags; and
periodically checking the PI real-time data tags against pre-determined standards or logic.

12. The non-transitory, computer-readable medium of claim 11, wherein detecting installation of a new well or piece of equipment is performed by a supervisory control and data acquisition (SCADA) PI server, which scans remote terminal unit (RTU) data through one or more existing communication channels.

13. The non-transitory, computer-readable medium of claim 12, comprising:
retrieving scanned RTU data along with a PI real-time tag and associated configuration attributes.

14. The non-transitory, computer-readable medium of claim 11, comprising:
automatically populating properties of the selected PI real-time data tags based on the pre-determined standards or logic.

15. The non-transitory, computer-readable medium of claim 14, wherein automatically populating properties of the selected PI real-time data tags is performed by machine learning (ML) algorithms.

16. The non-transitory, computer-readable medium of claim 11, wherein the selected PI real-time data tags are automatically configured in a demilitarized zone (DMZ) server and corporate PI server.

17. The non-transitory, computer-readable medium of claim 11, comprising:
determining that any of properties, description, or tag mask of the PI real-time data tags fails to follow the pre-determined standards or logic.

18. The non-transitory, computer-readable medium of claim 17, comprising:
receiving a notification that a property, description, or tag mask of the PI real-time data tags fails to follow the pre-determined standards or logic.

19. The non-transitory, computer-readable medium of claim 18, comprising:
receiving a recommended correction associated with the notification.

20. A computer-implemented system for plant information (PI) real-time data tag automatic configuration and quality assurance/quality control (QA/QC), comprising:
one or more computers; and
one or more computer memory devices interoperably coupled with the one or more computers and having tangible, non-transitory, machine-readable media storing one or more instructions that, when executed by the one or more computers, perform one or more operations, comprising:
detecting installation of a new well or piece of equipment;
triggering a plant information (PI) real-time data tag configuration workflow;
receiving a notification of a set of one or more potential PI real-time data tags to configure, wherein the set of one or more potential PI real-time data tags are associated with the new well or piece of equipment;
receiving, as selected PI real-time data tags, a selection from the set of one or more potential PI real-time data tags to configure;
automatically configuring the selected PI real-time data tags; and
periodically checking the PI real-time data tags against pre-determined standards or logic.
